(19) United States
(12) Patent Application Publication
(10) Pub. No.: US 2025/0286100 A1
(43) Pub. Date: Sep. 11, 2025

(54) SERVO POWERED CELL PULLER

(71) Applicant: The Boeing Company, Arlington, VA (US)

(72) Inventors: Dustin P. Greene, Aledo, TX (US); John M. Holder, Plano, TX (US)

(21) Appl. No.: 18/601,855

(22) Filed: Mar. 11, 2024

(51) Int. Cl. H01M 10/04

(52) U.S. Cl. CPC H01M 10/0404

(57) ABSTRACT

A powered battery cell puller system designed to assist in the removal of individual cells from a battery is disclosed. In one embodiment, the powered battery cell puller system is equipped with an electrically powered servo motor actuated jack screw or a pneumatically or hydraulically powered cylinder, and an end effector that couples to an accessible portion of an individual cell. The end effector can include an electromagnet that when energized attaches to the cell or a double half nut that mechanically connects to studs of the cell while maintaining electrical isolation of the studs to prevent shorting the cell. The resulting strong, predictable vertical movement is advantageous for removing cells from a battery with less deflection, torque stress or damage. Initially developed to aid in removal of cells from batteries, its design versatility extends to various other applications.

### BACKGROUND INFORMATION

### 1. Field

The present disclosure relates generally to a battery cell puller apparatus and battery cell puller methodologies, and more specifically to a powered battery cell puller system and associated methodologies.

### 2. Background

One previous approach to removing cells from batteries is screwing a T-Bar on to one of the studs of a cell and attempting to pull the T-Bar up manually. If this does not work, then a wooden 2×4 is typically used with a fulcrum to leverage the T-Bar up and the cell out of the battery.

However, a drawback of this approach is that the cell is not pulled straight up vertically, especially when leveraged. This is exacerbated when force applied as an impulse is used to dislodge the cell, for example when the cell is swollen. The deflection and consequent torque inevitably cause strain, often cause damage to the cell and/or the battery, and can even cause spillage of potassium hydroxide electrolyte from the cell. Other unresolved issues are the lack of repeatability and unpredictable production rates.

Therefore, it would be desirable to have a battery cell puller, as well as methods of using that puller that take into account at least some of the issues discussed above, as well as other possible issues.

### SUMMARY

There is a need for the following embodiments of the present disclosure. Of course, the present disclosure is not limited to these embodiments.

An embodiment of the present disclosure is a powered battery cell puller system designed to assist in the removal of individual cells from a battery. In one embodiment, the powered battery cell puller system is equipped with an electrically powered servo motor actuated screw to pull the cell. In another embodiment, the powered battery cell puller system is equipped with a hydraulically or pneumatically powered cylinder to pull the cell.

An embodiment of the present disclosure comprises an end effector that couples to an accessible portion of an individual cell. The end effector can include an electromagnet that when energized attaches to the cell. Alternatively, the end effector can include a double half nut that mechanically connects to the studs of the cell while maintaining electrical isolation of the studs to prevent shorting the cell.

The resulting strong, predictable vertical movement is advantageous for removing cells from a battery with less deflection, torque stress or damage. Initially developed to aid in removal of cells from batteries, its design versatility extends to various other applications.

An embodiment of the present disclosure provides a method for pulling a cell from a battery, comprising: positioning an end effector above a terminal end of the cell located in the battery; lowering the end effector toward the terminal end of the cell; coupling reversibly the end effector to the terminal end of the cell; and raising, using a source of power, the end effector and the cell relative to the battery to lift the cell and separate the cell apart from the battery.

Another embodiment of the present disclosure provides an apparatus for pulling a cell from a battery, comprising: a power source comprising an electrical power source; a gantry comprising a battery tray; an actuator coupled to the gantry and the power source, the actuator comprising a servo motor coupled to a jack screw supported by a least one ball screw; an end effector coupled to the actuator, the end effector comprising a threaded connector adapted to mechanically attach to at least one terminal of the cell of the battery, wherein the threaded connector comprises two half screws that are electrically isolated from one another; and a control system coupled to the power source and the actuator, the control system adapted to control raising and lowering the end effector relative to the battery tray using the actuator, wherein the control system comprises at least one relay to raise and lower the end effector, wherein the control system comprises at least one relay to control the end effector, wherein the control system comprises at least one relay to position the end effector above a terminal end of the cell located in the battery, and wherein the control system comprises a user interface panel.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of a block diagram of an apparatus comprising a powered battery cell puller in accordance with an illustrative embodiment;

FIG. 2 is an illustration of a gantry to provide X-Y-Z axis positionality to a powered battery cell puller in accordance with an illustrative embodiment;

FIG. 3 is an illustration of a servo motor powered ball screw actuator together with an end effector mechanically attached to a threaded terminal of a battery cell in accordance with an illustrative embodiment;

FIG. 4 is an illustration of an electrically isolating double half nut adapter to mechanically attach to two threaded terminals of a battery cell in accordance with an illustrative embodiment;

FIG. 5 is an illustration of a control panel for a powered battery cell puller in accordance with an illustrative embodiment;

FIG. 6 is an illustration of a flowchart of a process for pulling a cell from a battery in accordance with an illustrative embodiment;

FIG. 7 is an illustration of a flowchart of a process for locating the battery relative to an origin of the end effector; moving the end effector along at least one of an X axis and a Y axis relative to the battery; and moving the end effector along a Z axis relative to the battery in accordance with an illustrative embodiment;

FIG. 8 is an illustration of a flowchart of a process for decoupling reversibly the end effector from the terminal end of the cell; recoupling reversibly the end effector to the terminal end of the cell; and lowering the end effector and the cell relative to the battery to insert the cell into the battery in accordance with an illustrative embodiment;

FIG. 9 is an illustration of an aircraft manufacturing and service method in a form of a block diagram in accordance with an illustrative embodiment; and

FIG. 10 is an illustration of an aircraft in a form of a block diagram in which an illustrative embodiment may be implemented.

### DETAILED DESCRIPTION

Embodiments presented in the present disclosure and the various features and advantageous details thereof are explained more fully with reference to the nonlimiting embodiments that are illustrated in the accompanying drawings and detailed in the following description. Descriptions of well-known materials, techniques, components and equipment are omitted so as not to unnecessarily obscure the embodiments of the present disclosure in detail. It should be understood, however, that the detailed description and the specific examples are given by way of illustration only and not by way of limitation. Various substitutions, modifications, additions and/or rearrangements within the scope of the underlying inventive concept will become apparent to those skilled in the art from this disclosure.

An embodiment of this disclosure includes a powered battery cell puller tool and methodology. An embodiment of this disclosure can include a 3 axis positional, servo driven actuator cell puller that can orientate with respect to a battery, identify the cells, and pull the cells directly up to avoid damage to the cells and the balance of the battery. The 3 axis servo driven cell puller can include a gantry. The gantry can locate the cell using the origin or using machine vison. During reassembly of the battery, the operation works in reverse to install the cells.

An embodiment of this disclosure can include a servo to clamp the base of the battery in the orientation needed on a battery tray beneath the gantry. In this way the battery can be located adjacent the battery tray. This can define an origin with regard to the battery.

In an embodiment, the gantry can use an electromagnet to connect to a cell and then a servo on a ball screw pulls or pushes the cell directly up and down. The electromagnetic can be energized via a control panel or alternatively via a contact switch that is actuated by impingement by a surface of the cell.

In an alternative embodiment, the gantry can use a double half nut end effector made partially out of an insulating material such as plastic (e.g. delran, aka polyoxymethylene) and partially out of a resilient structural material such as stainless steel. The two half nuts enable quick threaded attachment and substantially simultaneous pulling from 2 studs (terminals) to evenly distribute the load, while ensuring the 2 studs of the battery don't short together during the pull operation. As the end effector moves towards the cell, the powered cell puller system energizes one or more electromagnets opening the end effector. The electromagnets pull the springs back as it slips over the studs and then deenergizes when in place closing the end effector to lock the half nuts. Once the cell is removed, the magnets can be energized again to permit removal of the cell from the end effector. Of course, the invention is not limited to this implementation and in an alternative embodiment the electromagnets when energized can close the end effector and the springs used to open the end effector when the electromagnets are de-energized.

An aircraft battery can be maintained by the disclosed apparatus and/or methods.

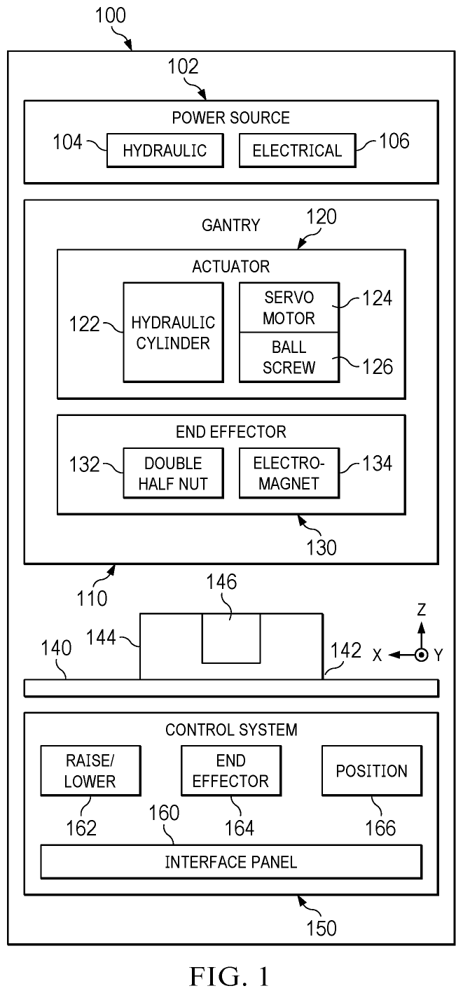

Turning now to FIG. 1, an illustration of a block diagram of a powered battery cell puller system 100 is depicted in accordance with an illustrative embodiment. The powered battery cell puller system 100 comprises a power source 102. In one embodiment the power source 102 can include a hydraulic power source 104. The hydraulic poser source can be a hydraulic pump. In an alternative embodiment the power source 102 can include and electrical power source 106.

The powered battery cell puller system 100 comprises a gantry 110. The gantry 110 includes an actuator 120. In one embodiment the actuator 120 can include a hydraulic cylinder 122. In an alternative embodiment, the actuator 120 can include a servo motor 124 mechanically engaged with a bowl screw 126.

The gantry 110 includes an end effector 130. In one embodiment the end effector 130 can include a double half nut 132. In an alternative embodiment the end effector 130 can include an electromagnet 134.

The powered battery cell puller system 100 comprises a battery tray 140. An origin 142 is defined on a surface of the battery tray 140. A battery 144 is located on a surface of the battery tray 140 the battery 144 includes a battery cell 146.

The powered battery cell puller system 100 comprises a control system 150. The control system 150 includes an interface panel 160. The control system 150 includes a relay 162 for raising and lowering the actuator. The control system 150 includes a relay 164 for operating the end effector. The control system 150 includes a relay 166 for controlling opposition of the end factor relative to the origin 142.

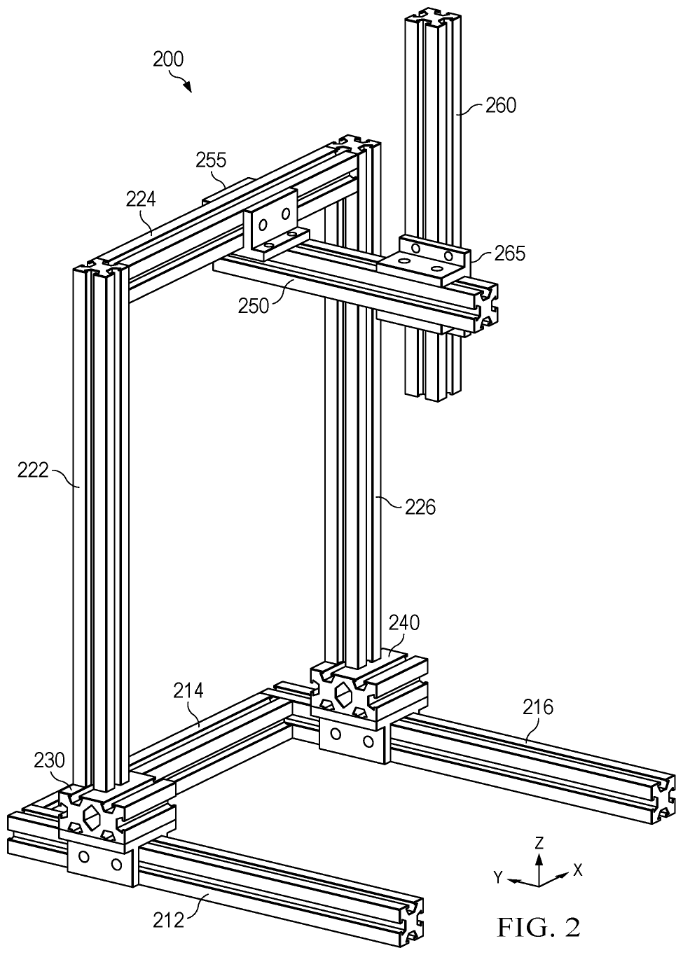

Referring to FIG. 2, a gantry 200 of a powered battery cell puller system to provide X-Y-Z axis positionality for an actuator relative to a battery is shown. The gantry includes left foot 212. The gantry 200 includes a center foot 214. The gantry 200 includes a right foot 216. The left foot 212, the center foot 214, and the right foot 216 are mechanically connected together.

The gantry 200 includes a left vertical riser 222 coupled to the left foot 212. In the depicted embodiment the left vertical riser 222 is movably coupled to the left foot 212 via a left footer 230 with that provides a movement capability along a Y axis. The left footer 230 can be servo motor powered. The gantry 200 includes a horizontal beam 224. The gantry 200 includes a right vertical riser 226 coupled to the right foot 216. In the depicted embodiment the right vertical riser 226 is movably coupled to the right foot 216 via a right footer 240 that provides a movement capability along the Y axis. The right footer 240 can be servo motor powered.

A cantilever 250 is coupled to the horizontal beam 224. In the depicted embodiment the cantilever 250 is mechanically connected to the horizontal beam 224 with a slidable coupling 255 that imparts a movement capability to the cantilever 250 along the X axis. The slidable coupling 255 can be servo motor powered. An actuator riser 260 is coupled to the cantilever 250. In the depicted embodiment the actuator riser 260 is mechanically connected to the cantilever 250 with a slidable coupling 265. The slidable coupling 265 imparts a movement capability to the actuator riser along a Z axis. The slidable coupling 265 can be servo motor powered.

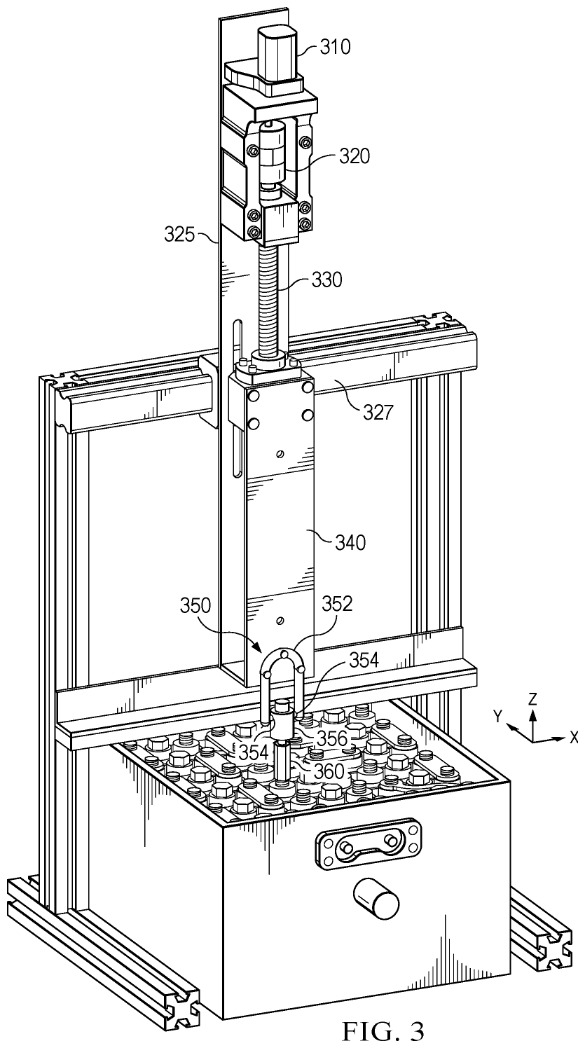

Referring to FIG. 3, a servo motor powered ball screw actuator together with an end effector of a powered battery cell puller system is shown. A servo motor 310 is coupled to a clutch-escapement 320. The servo motor 310 and the clutch-escapement 320 are mechanically connected to a web 325. The web is mechanically connected to a horizontal member 327. The horizontal member 327 can be the horizontal beam 224 shown in FIG. 2.

Referring again to FIG. 3, the clutch-escapement 320 is coupled to a ball screw 330. The ball screw 330 is coupled to an actuator 340. The actuator 340 is movably coupled to the horizontal member 327 so that the ball screw 330 can move the actuator 340 along the Z axis relative to the horizontal member 327. An end effector 350 is mechanically connected to the actuator 340.

The end effector 350 is removably coupled to a threaded terminal of a battery cell via double ended internally threaded adapter 360. Upward movement of the actuator 340 along the Z axis causes the end effector 350 and in turn the double ended internally threaded adapter 360 to lift the battery cell away from the balance of the battery.

The end effector 350 includes a U-shaped bracket 352 that include a pair of opposing pivot points 354. The end effector 350 includes a pivoting bracket 356 that is movably coupled to the pair of opposing pivot points 354. The pivoting bracket 356 provides a degree of freedom (rotation) around the x-axis and is coupled to the double ended internally threaded adapter 360. Of course, the invention is not limited to this embodiment and an alternative embodiment can include a hydraulic (and/or pneumatic) cylinder to move the actuator instead of (or in addition to) the servo motor and ball screw.

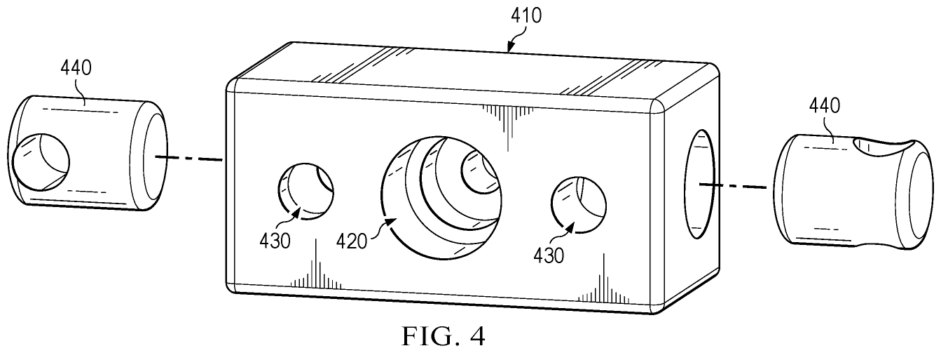

Referring to FIG. 4, an electrically isolating double half nut adapter end effector 410 of a powered battery cell puller system is shown. The electrically isolating double half nut adapter end effector 410 includes a central conduit 420 for mechanical attachment to an actuator of the powered battery cell puller system. The attachment can be via the pivoting bracket 356 shown in FIG. 3.

Referring again to FIG. 4, the electrically isolating double half nut adapter end effector 410 includes a pair of receivers 430 for simultaneous engagement with 2 threaded terminals of a battery cell (not shown in FIG. 4). The engagement can be implemented with a pair of half nuts located within the electrically isolating double half nut adapter end effector 410. The pair of half nuts can be closed onto the 2 threaded terminals of the battery by moving plugs 440 toward the central conduit 420. This movement of the plugs 440 can be implemented electromagnetically by energizing a circuit that includes one or more electromagnets. In this embodiment, to release the 2 threaded terminals, electromagnetic circuit can be de-energized and a restorative force (e.g. springs, polyurethane blocks, etc.) allowed to move plugs 440 away from the central conduit 420 and out of engagement with the 2 threaded terminals. Of course, the invention is not limited to this embodiment and in an alternative embodiment the electromagnets when energized can open the end effector while the restorative force closes the half nuts of the end effector when the electromagnets are de-energized.

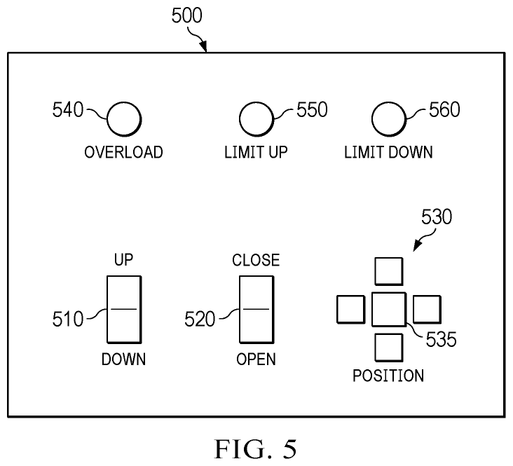

Referring to FIG. 5, a control panel 500 of a powered battery cell puller system is shown. The control panel 500 includes an up down control switch 510. The control panel 500 includes a close open switch 520. The control panel 500 includes a position control switch 530 to control the XY axis location of the actuator and in turn the end effector. A central portion 535 of the position control switch 530 can automatically return the XY position of the end effector to an origin location (0 position).

The control panel 500 can include an overload warning light 540. The control panel 500 can include a limit up warning light 550. The control panel 500 can include a limit down warning light 560. One or more of these warning lights can also be associated with an audible warning tone.

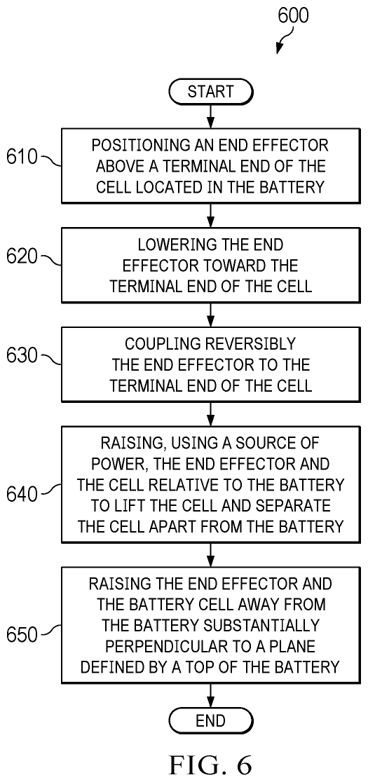

Referring to FIG. 6, a process 600 for pulling a cell from a battery using a powered battery cell puller system is shown. Block 610 includes positioning an end effector above a terminal end of the cell located in the battery. Block 620 includes lowering the end effector toward the terminal end of the cell. Block 630 includes coupling reversibly the end effector to the terminal end of the cell. Block 640 includes raising, using a source of power, the end effector and the cell relative to the battery to lift the cell and separate the cell apart from the battery. Block 650 includes raising the end effector and the battery cell away from the battery substantially perpendicular to a plane defined by a top of the battery.

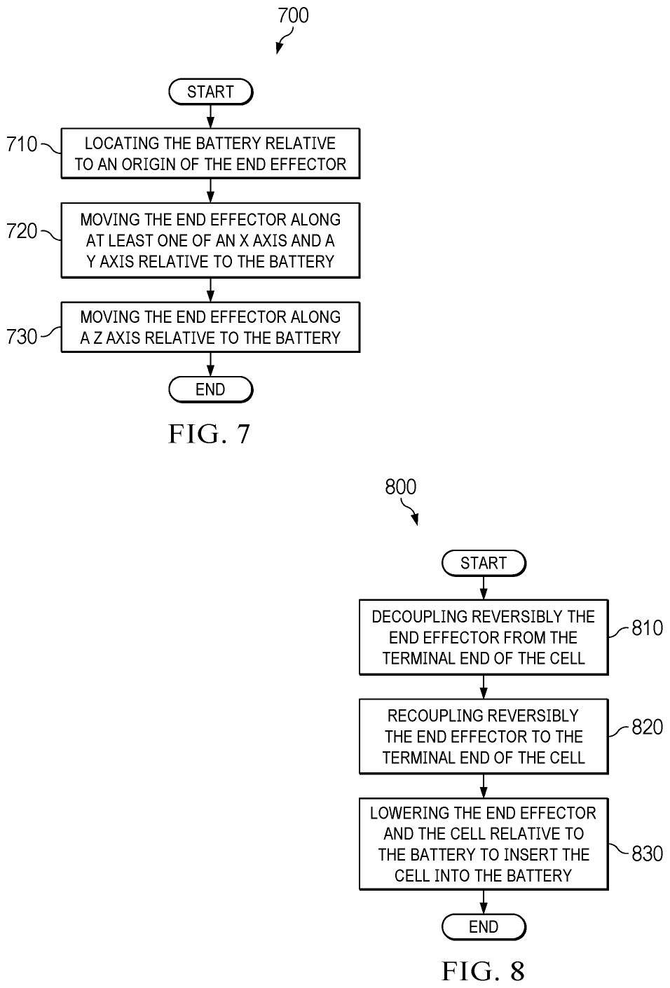

Referring to FIG. 7, a process 700 for moving an end effector with regard to a battery that is located relative an origin of the end effector is shown. Block 710 includes locating a battery relative to an origin of an end effector. Block 720 includes moving the end effector along at least one of an X axis and a Y axis relative to the battery. Block 730 includes moving the end effector along a Z axis relative to the battery is shown.

Referring to FIG. 8, a process 800 for retrieving a cell from a battery and reinserting the call back into the battery is shown. Block 810 includes decoupling reversibly an end effector from a terminal end of a cell. Block 820 includes recoupling reversibly the end effector to the terminal end of the cell. Block 830 includes lowering the end effector and the cell relative to the battery to insert the cell into the battery is shown.

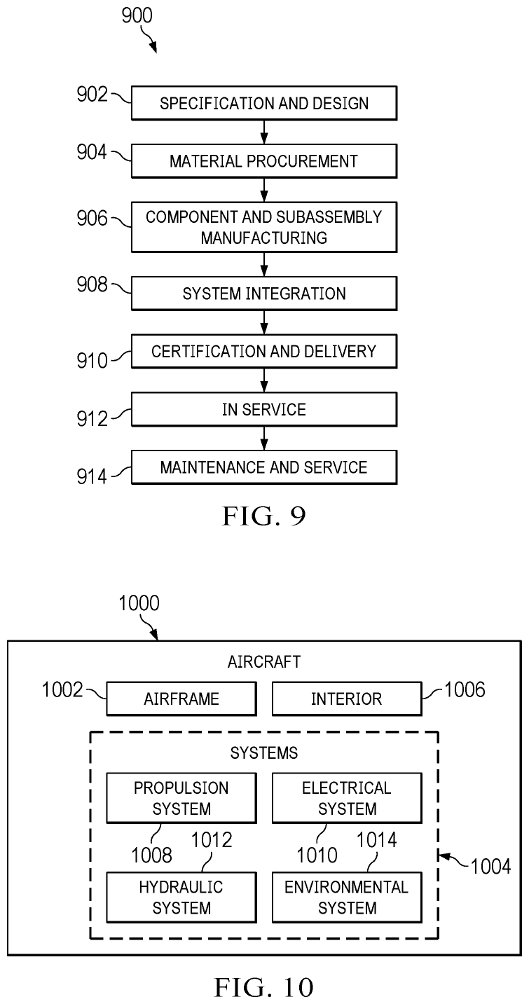

Illustrative embodiments of the present disclosure may be described in the context of aircraft manufacturing and service method 900 as shown in FIG. 9 and aircraft 1000 as shown in FIG. 10. Turning first to FIG. 9, an illustration of an aircraft manufacturing and service method in the form of a block diagram is depicted in accordance with an illustrative embodiment. During pre-production, aircraft manufacturing and service method 900 may include specification and design 902 of aircraft 1000 in FIG. 10 and material procurement 904.

During production, component and subassembly manufacturing 906 and system integration 908 of aircraft 1000 takes place. Thereafter, aircraft 1000 may go through certification and delivery 910 in order to be placed in service 912. While in service 912 by a customer, aircraft 1000 is scheduled for routine maintenance and service 914, which may include modification, reconfiguration, refurbishment, or other maintenance and service.

Each of the processes of aircraft manufacturing and service method 900 may be performed or carried out by a system integrator, a third party, and/or an operator. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

Illustrative embodiments of the present disclosure may be described in the context of aircraft manufacturing and service method 900 as shown in FIG. 9 and aircraft 1000 as shown in FIG. 10. Turning first to FIG. 9, an illustration of an aircraft manufacturing and service method in the form of a block diagram is depicted in accordance with an illustrative embodiment. During pre-production, aircraft manufacturing and service method 900 may include specification and design 902 of aircraft 1000 in FIG. 10 and material procurement 904.

During production, component and subassembly manufacturing 906 and system integration 908 of aircraft 1000 takes place. Thereafter, aircraft 1000 may go through certification and delivery 910 in order to be placed in service 912. While in service 912 by a customer, aircraft 1000 is scheduled for routine maintenance and service 914, which may include modification, reconfiguration, refurbishment, or other maintenance and service.

Each of the processes of aircraft manufacturing and service method 900 may be performed or carried out by a system integrator, a third party, and/or an operator. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 10, an illustration of an aircraft in a form of a block diagram is depicted in which an illustrative embodiment may be implemented. In this example, aircraft 1000 is produced by aircraft manufacturing and service method 900 of FIG. 9 and may include airframe 1002 with plurality of systems 1004 and interior 1006. Examples of systems 1004 include one or more of propulsion system 1008, electrical system 1010, hydraulic system 1012, and environmental system 1014. Any number of other systems may be included.

Apparatuses and methods embodied herein may be employed during at least one of the stages of aircraft manufacturing and service method 900. One or more illustrative embodiments may be manufactured or used during at least one of component and subassembly manufacturing 906, system integration 908, in service 912, or maintenance and service 914 of FIG. 9.

The description of the different illustrative embodiments has been presented for purposes of illustration and description, and is not intended to be exhaustive or limited to the embodiments in the form disclosed. Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method for pulling a cell from a battery, comprising:
positioning an end effector above a terminal end of the cell located in the battery;
lowering the end effector toward the terminal end of the cell;
coupling reversibly the end effector to the terminal end of the cell; and
raising, using a source of power, the end effector and the cell relative to the battery to lift the cell and separate the cell apart from the battery.

2. The method of claim 1, wherein raising comprises raising the end effector and the cell away from the battery substantially perpendicular to a plane defined by a top of the battery.

3. The method of claim 1, further comprising locating the battery relative to an origin of the end effector.

4. The method of claim 3, wherein positioning the end effector comprises moving the end effector along at least one of an X axis and a Y axis relative to the battery.

5. The method of claim 3, wherein lowering comprises moving the end effector along a Z axis relative to the battery.

6. The method of claim 1, wherein coupling comprises energizing an electromagnet that attaches to the terminal end of the cell.

7. The method of claim 1, wherein coupling comprises mechanically connecting the end effector to the terminal end of the cell.

8. The method of claim 1, further comprising
decoupling reversibly the end effector from the terminal end of the cell.

9. The method of claim 8, further comprising
recoupling reversibly the end effector to the terminal end of the cell.

10. The method of claim 9, further comprising lowering the end effector and the cell relative to the battery to insert the cell into the battery.

11. An aircraft battery serviced using the method of claim 1.

12. An apparatus for pulling a cell from a battery, comprising:
a power source;
a gantry comprising a battery tray;
an actuator coupled to the gantry and the power source;
an end effector coupled to the actuator; and
a control system coupled to the power source and the actuator, the control system adapted to control raising and lowering the end effector relative to the battery tray using the actuator.

13. The apparatus of claim 12, wherein the power source comprises an electrical power source and the actuator comprises a servo motor coupled to a ball screw.

14. The apparatus of claim 12, wherein the power source comprises a hydraulic pump and the actuator comprises a hydraulic cylinder.

15. The apparatus of claim 12, wherein the end effector comprises a threaded connector adapted to mechanically attach to at least one terminal of the cell of the battery.

16. The apparatus of claim 15, wherein the threaded connector comprises two half nuts that are electrically isolated from one another.

17. The apparatus of claim 12, wherein the end effector comprises at least one electromagnet.

18. The apparatus of claim 12, wherein the control system comprises at least one relay to raise and lower the end effector.

19. The apparatus of claim 18, wherein the control system comprises at least one relay to control the end effector.

20. The apparatus of claim 19, wherein the control system comprises a user interface panel.

21. The apparatus of claim 20, wherein the control system comprises at least one relay to position the end effector above a terminal end of the cell located in the battery.

22. The apparatus of claim 12, further comprising a battery located adjacent the battery tray.

23. An aircraft battery maintained by the apparatus of claim 12.

24. An apparatus for pulling a cell from a battery, comprising:
a power source comprising an electrical power source;
a gantry comprising a battery tray;
an actuator coupled to the gantry and the power source, the actuator comprising a servo motor coupled to a jack screw supported by a least one ball screw;
an end effector coupled to the actuator, the end effector comprising a threaded connector adapted to mechanically attach to at least one terminal of the cell of the battery, wherein the threaded connector comprises two half screws that are electrically isolated from one another; and
a control system coupled to the power source and the actuator, the control system adapted to control raising and lowering the end effector relative to the battery tray using the actuator, wherein the control system comprises at least one relay to raise and lower the end effector, wherein the control system comprises at least one relay to control the end effector, wherein the control system comprises at least one relay to position the end effector above a terminal end of the cell located in the battery, and wherein the control system comprises a user interface panel.
